(19) United States
(12) Patent Application Publication
(10) Pub. No.: US 2025/0258882 A1
(43) Pub. Date: Aug. 14, 2025

(54) SYSTEM AND METHOD FOR AUTOMATICALLY IDENTIFYING IMPORTANT NEWS ACROSS LARGE DATASETS

(71) Applicant: Primer Technologies, Inc., San Francisco, CA (US)

(72) Inventors: John BOHANNON, San Francisco, CA (US); Oleg VASILYEV, Palo Alto, CA (US)

(21) Appl. No.: 19/053,339

(22) Filed: Feb. 13, 2025

Related U.S. Application Data
(60) Provisional application No. 63/553,104, filed on Feb. 13, 2024.

(51) Int. Cl. G06F 16/954; G06F 16/35

(52) U.S. Cl. CPC G06F 16/954; G06F 16/35

(57) ABSTRACT

A method for automatically identifying important and urgent news (IUN) in a large set of data comprises obtaining the large set of data in a textual-format, the large set of textual-data data contain a plurality of individual texts; clustering the textual-format data into a plurality of clusters; for each cluster, calculating the distances to all other clusters in the plurality of clusters and from those calculated distances determining a radius and a median of those calculated distances and then obtaining a difference between the radius and the median; and using the difference to identify important and urgent news in the large set of data.

### CROSS REFERENCE TO RELATED APPLICATION

This application is a continuation of U.S. Patent Application Ser. No. 63/553,104, filed on Feb. 13, 2024, entitled “System and Method for Automatically Identifying Important News Across Large Datasets,” the content of which is incorporated herein by reference in its entirety.

### FIELD OF THE INVENTION

The present invention relates generally to a computer system for real-time information processing techniques used in uncovering important and urgent news (IUN). More specifically, the present invention relates to automated techniques for identifying important and urgent news across large datasets, such as news organization websites and social media platforms.

### BACKGROUND OF THE INVENTION

Generally speaking, “news” is published information regarding current events. Those current events may comprise, for instance, information about agriculture, business, conflicts, construction, death announcements, economics, elections, energy, environmental conditions, governmental operations, job market (e.g., layoffs, openings, promotions), natural disasters, politics, population, public health, technology, and weather events. Some news is important, viz. presidential election results. Other news is urgent, viz. the moving location of a fire line in a forest fire. A lot more news may be neither important nor urgent.

There are thousands of potential sources of important and urgent news (IUN). In addition to traditional media sources (e.g., ABC, Al Jazeera, BBC, CBS, CNN, DailyMail, Fox News, The Guardian, NBC, NPR) and social media (e.g., Facebook, Instagram, X (formerly known as Twitter)), there are hundreds upon hundreds other sources of information. Such information may be, for example, as audio, imagery, textual, and data. For instance, a video shared to Instagram showing a wildfire approaching an end-user's home may provide audio, imagery, text, and embedded time-stamp and GPS data that may provide urgent information regarding fire location and strength, wind speed, etc. In another example, a Tweet may provide information, perhaps photographic, insinuating that a loved-one is leaving on a military deployment. Most news is important only to select audiences and occasionally in select circumstances.

Methods of converting audio and imagery (e.g., charts, graphs, photos, video) into textual description is well-known. Accordingly, this application may collectively refer to all potential sources of news information as “news articles.”

Clustering is a well-known method of grouping sets of news articles into one or more groups (“clusters”), each cluster having one or more similarities defined by the nature of a particular query. There are dozens of known clustering methods that may be used to create these groupings. Currently, clustering of news articles provides efficient aggregation that can be used for trend monitoring, comprehensive coverage, news categorization, and can be beneficial for content summarization.

Large language models (LLMs) are a type of artificial neural network commonly used to generate and/or understand language after learning statistical relationships found in a language by training the model. One notable LLM is the generative pre-training transformers (“GPT”) developed by OpenAI, Inc. of San Francisco, California, is ChatGPT. The proficiency of Large Language Models (LLMs) have advanced so much that LLM may be used for annotating texts with arguable success (Gilardi et al., 2023; Kuzman et al., 2023; Törnberg, 2023), at least for tasks with low requirements of domain specific knowledge (Weber and Reichardt, 2023; Lu et al., 2023). Using LLM (or even smaller language models) on large amount of daily news is not always desirable, for cost and processing time reasons.

As such there is a need to develop a method for uncovering important and urgent news (IUN) across large datasets, such as news organization websites and social media platforms that delivers the performance of an LLM while minimizing the use of LLMs because of their cost and required processing time.

These and other needs will be apparent to those of ordinary skill in the art after reviewing the present specification.

### SUMMARY OF THE DISCLOSURE

This summary is provided to introduce select concepts that are more fully described in the Detailed Description. This summary is not intended to identify key or essential features of the claimed subject matter, nor is it intended to limit the scope of the claims set forth below.

The present disclosure is directed to the discovery that the less intensive application of clustering mechanisms is an acceptable substitute for the use of LLM in identifying important and urgent news (IUN) across a large dataset while minimizing costs, processing time and energy expended in producing results. In particular, the specification discloses how to process the clusters in a clustered dataset of news to achieve a strong correlation to results of the importance and urgency of news (IUN) assessed by the more-intensive use of LLMs. Moreover, the invention systems and methods disclosed provide a quicker mechanism to such rankings than LLMs.

Experimental results set forth below illustrate that this result holds across different news datasets, dataset sizes, clustering algorithms and embeddings when comparing various clustering techniques against OpenAI's “GPT3.5-Turbo.” Experimental results are disclosed using four different news datasets, four different data sizes, three different clustering algorithms, and three text embeddings to support the utility of the systems and methods disclosed herein. Each of these experimental approaches represent preferred methodologies to achieve the desired results, but these experimental examples are not exhaustive of the scope of the present invention, as would be understood by those of ordinary skill in the art having the present specification and drawings before them.

Thus, the present application discloses systems and methods based on various clustering techniques as a lower-cost alternative to LLMs for identifying the most important urgent news, or for filtering out unimportant articles.

### BRIEF DESCRIPTION OF THE DRAWINGS

FIG. 1 of the drawings is a flow chart illustrating the general approach to the inventive method disclosed.

FIG. 2 of the drawings is a histogram (20 bins) of LLM generated IUN average cluster scores for clusters from all the example clustering cases used in the experiments underlying this disclosure.

FIG. 3 of the drawings is a histogram (50 bins) of the standard deviations of a cluster's LLM generated IUN scores using the same clusters represented by FIG. 2.

FIG. 4 of the drawings is a histogram of the distribution of average IUN scores of the clusters for the various experimental datasets.

FIG. 5 of the drawings is a histogram of the distribution of average IUN scores of the clusters based on dataset sizes.

FIG. 6 of the drawings is a histogram of the distribution of average IUN scores of the clusters based on text embedding type used.

FIG. 7 of the drawings is a histogram of the distribution of average IUN scores of the clusters based on clustering algorithm used.

FIG. 8 of the drawings is a histogram of the distribution of average IUN scores of the clusters based on the use of various UMAP dimensional reduction parameters.

FIG. 9 of the drawings illustrates the normalized gap between cluster ranks (IUN vs. DD⁹⁰⁻⁵⁰).

FIG. 10 of the drawings is a block diagram of a potential system to deploy the inventive system and methods.

### DETAILED DESCRIPTION OF THE INVENTION

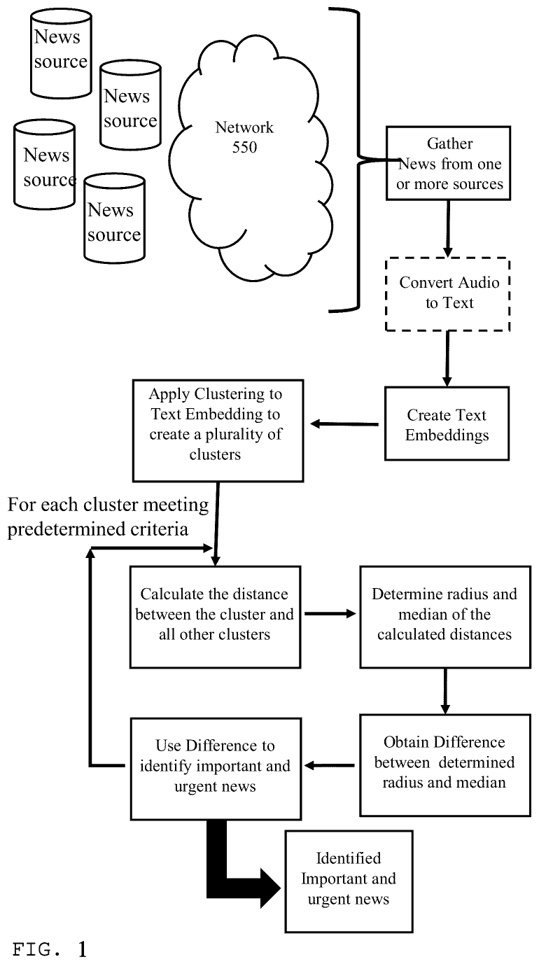

As shown in FIG. 1, the present invention generally comprises a method for automatically identifying important and urgent news (IUN) in a large set of data. The method may be applied to the large set of data in a textual-format, wherein the large set of textual-data data contain a plurality of individual texts. These large sets of textual data may be found in individual location (i.e., a single server) or across multiple electronic repositories of data. The single server and/or the multiple electronic repositories of data may be local to the computer system running the inventive method, may be accessed across a large area network, wide area network, including the Internet. The large set of data may include data stored in an audio or audio-visual format, in which case the audio may be converted to text using any of a variety of well known speech-to-text conversion programs. The data may be gathered by the system in real-time or it may be gathered in advance and stored for later processing. It is also contemplated that combinations of the foregoing may be desired. In association with the experiments disclosed more fully below, the dataset is taken in four sizes (i.e., the number of first texts taken for clustering: 5K, 10K, 15K and all 20K). The clustering is done on embeddings of the top chunk of each text using three example embeddings:
MPN: all-mpnet-base-v2 (https://www.sbert.net/docs/pretrained_models.html) (Reimers and Gurevych, 2019)
L6: all-MiniLM-L6-v2 (a lighter sbert embedding)
E5: multilingual-e5-small (https://huggingface.co/intfloat/multilingual-c5-small) (Wang et al., 2022)

The method clusters the textual-format data into a plurality of clusters. This clustering may be performed using one or more clustering techniques, such as HDBSCAN (one potential embodiment of which may be found at https://github.com/scikit-learn-contrib/hdbscan; and described by Campello et al., 2013; McInnes and Healy, 2017), Agglomerative and KMeans (one potential embodiment of which may be found at https://scikit-learn.org/stable/modules/clustering.html).

Experiments that show the advantages of the inventive techniques disclosed herein indicate that the application of at least these three exemplary, very different clustering techniques as part of the present invention provides performance reasonably equivalent to the more computationally and cost-expensive LLM approach to IUN characterization. Preferably, clustering is done with each clustering algorithm targeting a number of clusters in range between 20 and 100 with step 10 (for HDBSCAN we use flat clustering).

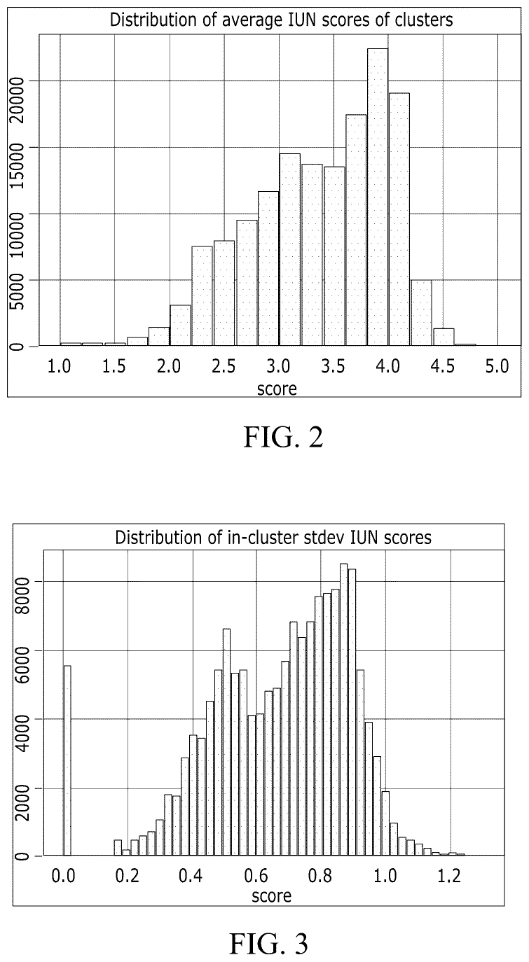

In the experiments, disclosed below, the IUN was considered for clustering cases that succeeded providing not less than 20 clusters where for all clusters that contained at least three samples. Where the clusters meet these criteria, an IUN score is assigned to each cluster that is an average of IUN scores of all the texts within the cluster. The distribution of the cluster LLM-generated IUN scores over the clustering cases used in the experiments is shown in FIG. 2. Based on the experimental data, each cluster's score was well defined, with the experiments indicating that the standard deviation over the cluster's items is typically less than 1.0. As shown in the figures, the distribution in the experimental data was reasonably wide, suggesting that IUN scores inside a typical cluster are not distributed randomly but grouped close. Indeed, the standard deviation of IUN scores inside each cluster (in the experimental set) was typically lower than 1.0, as shown in FIG. 3.

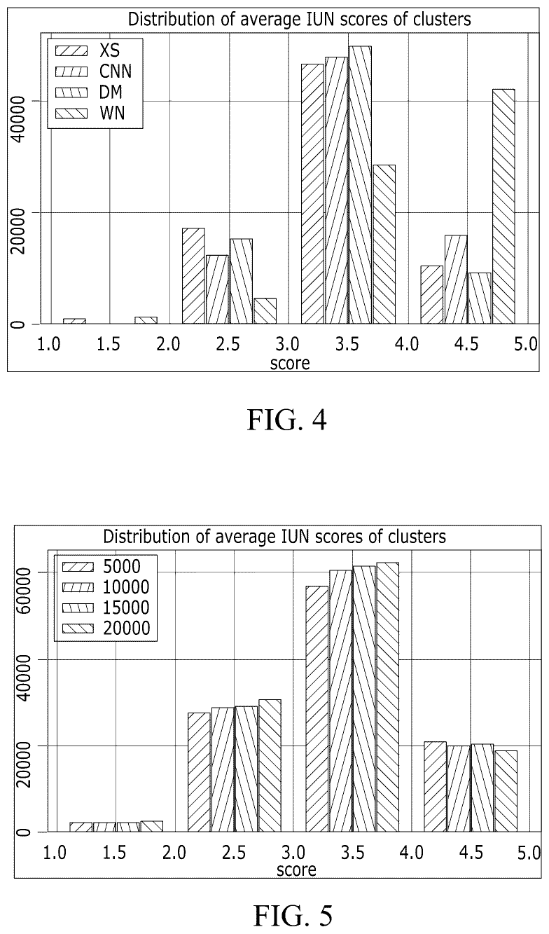

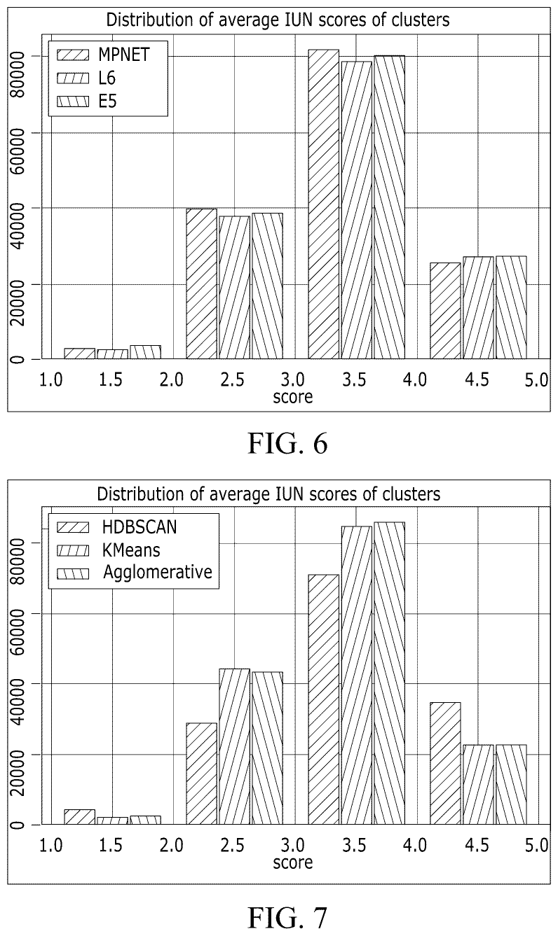

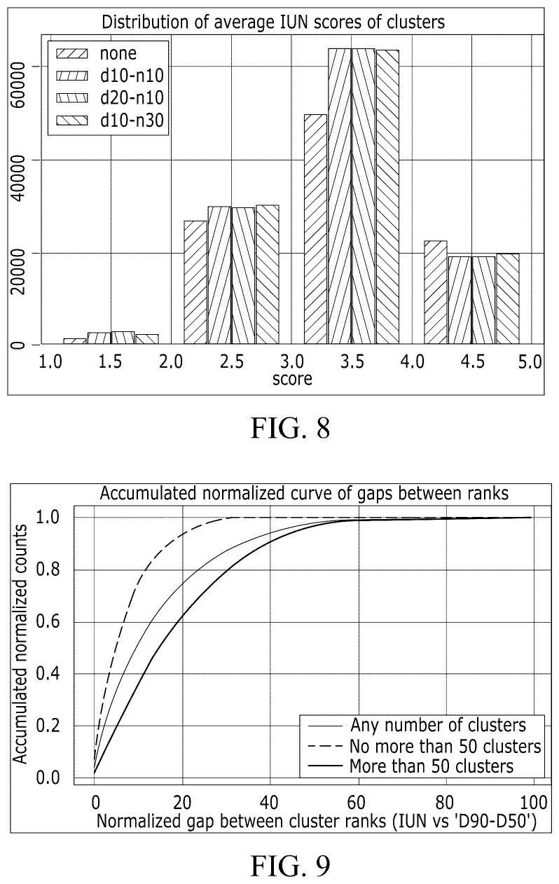

As might have been expected for a news data, in the experimental sets most clusters have IUN around 4 and 3 (on the Likert Scale established above). Split of the histogram by datasets, dataset sizes, embeddings, clustering algorithms or UMAP versions also appear reasonable. This information is disclosed for the experimental data set in FIG. 4 (by dataset); FIG. 5 (by dataset sizes), FIG. 6 (by embedding type (e.g., MPNET, L6, E5)); FIG. 7 (by clustering algorithm type (e.g., HBDSCAN, KMeans, Agglomerative)); FIG. 8 (by UMAP type, wherein ‘dN-nM’ means a UMAP to dimension N, with number of neighbors M).

FIG. 4 illustrates that the WN dataset differs from the other datasets, as may be expected given its special generation (see, github.com/PrimerAI/primer-research/trec/main/wikinews). It appears that a relatively high fraction of articles in the WN dataset with high IUN (as compared to other news datasets (XS, CNN, and DM)) may be due to the fact that all the articles in the WN dataset were already in WikiNews (https://www.wikinews.org/). FIG. 5 illustrates that there is only very weak dependency on the data size.

FIG. 6 illustrates that at least with respect to the experimental data there appears to be no strong dependency on the embeddings used. FIG. 7 illustrates, however, that there is a big difference between the distribution for HDBSCAN vs two other clustering algorithms. The experiments also illustrated that the HDBSCAN clustering technique also provides higher correlation between DD⁹⁰⁻⁵⁰ and IUN.

FIG. 8, illustrates distribution of average IUN scores of clusters including four UMAP versions: UMAP with dimension 20 and number of components 10, UMAP with dimension 10 and number of components 10 or 30, and no UMAP (the original embeddings). We present the distribution counted into bins 1-2, 2-3, 3-4 and 4-5 and split in several ways. Overall, FIG. 8 illustrates that no-UMAP has a distribution somewhat different from UMAP. (Recall here with respect to these data that the total number of cases may be not the same for different splits, because the experimental results included only clustering cases that are successful in producing between 20 and 100 clusters with each cluster containing at least 3 items.)

The disclosed approach to estimating IUN from the clustering result assumes that important urgent news may appear, at least to some extent, in coverage of multiple topics. This would make some clusters closer than they would be otherwise. From the point of view of a cluster with high IUN score, the clusters that are not too far would be “pulled” closer to the cluster. This assumption resulted in the recognition that simple features reflecting such “pull” ended up correlating well with LLM-generated IUN scores.

Based on the foregoing discovery, after the textual-formatted data is clustered, for each cluster, the present method calculates the distances to all other clusters in the plurality of clusters and from those calculated distances determines a radius and a median of those calculated distances and then obtains a difference between the radius and the median. This difference, in turn, identifies important and urgent news in the large set of data. In particular, the radius may be calculated using 90% rather than 100%. Thus, in a preferred embodiment of such simple cluster feature: the difference between two percentiles of the distances:

$${DD}^{90 - 50} = {D}_{90} - {D}_{50} \qquad ( 1 )$$

To calculate Dₚ for the cluster, p being any number between 0 and 100, we gather distances from the center of the cluster to the centers of all the other clusters. Then Dₚ is a distance corresponding to the percentile p of these distances. Essentially, DD⁹⁰⁻⁵⁰ is a difference between the “radius” of the data (from the point of view of the cluster) and the median distance. In one embodiment, the “radius” is taken at 90% rather than 100% to make it robust against outlier clusters. The median is a robust measure of the “pull” of some clusters by importance and novelty of the cluster.

As noted above, the method may use a dimension reduction technique, such as UMAP (the preferred version of which may be publicly found at https://github.com/lmcinnes/umap; and discussed in McInnes et al., 2020. UMAP may be applied to the embeddings, in the preferred embodiment with dimension 20 and number of components 10. UMAP (Uniform Manifold Approximation and Projection) is a dimension reduction technique that can be used for visualisation similarly to t-SNE, but also for general non-linear dimension reduction. Sec, McInnes, L, Healy, J, UMAP: Uniform Manifold Approximation and Projection for Dimension Reduction, ArXiv e-prints 1802.03426, 2018. Embodiments where UMAP is applied with dimension 10 (and number of components 10 or 30) to the original embeddings was also successfully studied, along with instances where dimension reduction was not applied.

Experiments with the Novel Systems and Methods

To assess the efficacy of this novel method (and associated system) against the prior art LLM approach, experiments were conducted. In those experiments, important and urgent news (IUN) is expressed as a sentiment to be scored on the Likert Scale—a psychometric scale named after its inventor, Rensis Likert—which is commonly used in research questionnaires. The Likert Scale scores responses along a range. The Likert Scale has been used by others in data science, for example, to classify the relevance of tweets (Gilardi et al., 2023) or to score financial sentiment (Fatemi and Hu, 2023). In particular, the IUN score, was defined by Likert Scale, as follows:
1: The text is not a news article.
2: The news in the text can be perceived as not important and not urgent.
3: The news in the text can be perceived as having low importance and low urgency.
4: The news in the text can be perceived as important and urgent.
5: The news in the text can be perceived as highly important and urgent.

In the experiments assessing the efficacy of the present invention against the prior art LLM models, the prompt used for scoring IUN via the large language model (LLM) is shown below:
Assign a score in Likert scale (1 to 5) to rate the importance and urgency of a news article. Your answer should contain only one digit: 1, 2, 3, 4 or 5. Here is a simple guide for assigning the score to the text:
1: The text is not a news article.
2: The news in the text can be perceived as not important and not urgent.
3: The news in the text can be perceived as having low importance and low urgency.
4: The news in the text can be perceived as important and urgent.
5: The news in the text can be perceived as highly important and urgent.
This is the text: [insert dataset or pointer to dataset here]

The LLM used in the experiments was GPT-3.5-Turbo with temperature set to zero and maximal number of output tokens set to 1. Any experimental result that was not one of the tokens (i.e., “1”, “2”, “3”, “4”, “5”) was considered a scoring failure and excluded from the dataset. The fraction of such failures was below 1%. (During the experiments, by allowing a longer LLM output, it appeared that many failures came from the LLM trying to output not a single token but rather a sentence, either describing or explaining the result.) The frequency of such failures may be decreased by adding repeated attempts to score, with gradual increase of the temperature and with selection of the first non-failed result. However, since the fraction of failures was less than 1% (even at zero temperature), for simplicity and easy repeatability, only the “immediately correct” zero-temperature scores were provided in the experimental results.

There were additional experiments conducted with other prompt versions. For example:
You are a labeler, skilled in rating the importance and urgency of news. You are using Likert scale (1 to 5):
1: The text does not have news.
2: The news in the text can be perceived as not important and not urgent.
3: The news in the text can be perceived as having low importance and low urgency.
4: The news in the text can be perceived as important and urgent.
5: The news in the text can be perceived as highly important and urgent.
Rate the provided text. Respond with one digit: 1, 2, 3, 4 or 5. [insert text or pointer to text here]

As would be understood by those of ordinary skill in the art, good prompts can generally decrease the fraction of failures. However, the experiments conducted in association with this invention never achieved completely failure-free scoring across all four news datasets tested. The difference in scoring results provided by prompting is negligible if the definitions of the Likert scale are kept the same, and if the statements about the scoring goal are clearly separated. However, using complicated sentences or not insisting clearly enough on the format of the output (single token between “1” and “5”) leads to strong increase of the scoring failures.

For comparison, comparative experiments were also conducted against much lighter scoring alternatives to GPT-3.5: classification by bart-large-mnli (disclosed in Yin et al., 2019 and may be found at https://huggingface.co/facebook/bart-large-mnli) and by its even lighter distilled version distilbart-mnli-12-1 (https://huggingface.co/valhalla/distilbart-mnli-12-1). These lighter models provide a faster alternative to LLM scoring. The IUN score from these models is picked up as a logit of the first class from the classification on only two classes: “urgent” and “not urgent” (the urgency may be the main property of important urgent news). (Other experiments, appeared to show that other classification choices, such as [“important”, “not important”], [“news”, “not news”] have much weaker correlations with the LLM generated score, and provided less convincing examples of scores. This led to the experimental conclusion that the urgency may be the main indicator of truly “important urgent news”.)

The scores obtained using these much lighter scoring alternatives correlated well with the LLM generated score; as shown here:

| Kendall's τ Correlation | XS | CNN | DM | WN |
|---|---|---|---|---|
| LLM-B | 0.21 | 0.26 | 0.20 | 0.25 |
| LLM-D | 0.25 | 0.22 | 0.24 | 0.20 |
| B-D | 0.33 | 0.39 | 0.32 | 0.35 |

In the table above, the scores produced by GPT-3.5-Turbo, by bart-large-mnli and by distilbart-mnli-12-1 are denoted as LLM, B and D, respectively and the news datasets used were:
XS: First 20K texts of XSum dataset (https://huggingface.co/datasets/EdinburghNLP/xsum) (Narayan et al., 2018)
CNN: First 20K texts of CNN part of CNN/Daily Mail dataset (https://huggingface.co/datasets/cnn_dailymail) (Hermann et al., 2015; See et al., 2017)
DM: First 20K texts of Daily Mail part of CNN/Daily Mail dataset.
WN: First 20K English texts of WikiNews dataset (https://github.com/PrimerAI/primer-research) (Vasilyev et al., 2023)

The foregoing table provides the correlations of scores obtained from the top chunk of the text; with the “top chunk” consisting of as many sentences as fits into 1000 characters. Examples of texts corresponding to different IUN scores are provided to demonstrate LLM-generated IUN on several examples, for each IUN score from 5 down to 1 by selecting the very first couple of articles in dataset XSum (BBC news) for which LLM (GPT3.5-Turbo) produced that score. For sake of clarity regarding the experimental examples, the “top chunk” of the XS (Xsum) data (preceded by the IUN scores for each), comprised:
1 An extensive aerial and underwater survey has revealed that 93% of Australia's Great Barrier Reef has been affected by coral bleaching.
5 The Queen has made her first visit to a World War Two concentration camp, Bergen-Belsen, in northern Germany.
4 Clean-up operations are continuing across the Scottish Borders and Dumfries and Galloway after flooding caused by Storm Frank.
4 Two tourist buses have been destroyed by fire in a suspected arson attack in Belfast city centre.
3 Lewis Hamilton stormed to pole position at the Bahrain Grand Prix ahead of Mercedes team-mate Nico Rosberg.
3 Manchester City midfielder Ilkay Gundogan says it has been mentally tough to overcome a third major injury.
2 Defending Pro12 champions Glasgow Warriors bagged a late bonus-point victory over the Dragons despite a host of absentees and two yellow cards.
2 Newport Gwent Dragons number eight Ed Jackson has undergone shoulder surgery and faces a spell on the sidelines.
1 Read match reports for Tuesday's 10 games in the Championship, including Newcastle's 6-0 pummelling of Queens Park Rangers.
1 Double Rio Olympics gold medallist Laura Kenny (nee Trott) recognises the importance of sporting volunteers—the Unsung Heroes—and wants you to nominate yours.

Similarly, the “top chunk” of the CNN part of CNN/DailyMail dataset (preceded by the IUN scores for each) is provided here:
5 NEW: Guinean government says most victims were crushed in the crowd. United Nations, citing media reports, said at least 58 people died. African Union expressed its “grave concern” about the situation.
5 33 killed in suicide bombing at reconciliation conference in Baghdad. Tuesday's attack came as tribal leaders were attending conference. Bombing came 3 days after Iraqi PM urged nation's sheikhs to join government.
4 U.S.-based scientists say their data points toward the existence [sic] of the Higgs boson. Finding the Higgs boson would help explain the origin of mass. But the research at the Tevatron collider doesn't provide a conclusive answer. Attention now turns to a seminar Wednesday on data from the Large Hadron Collider.
4 Zimmerman posts $5,000 bail; he was accused of throwing [sic] a bottle at a girlfriend. “He hasn't been very lucky with the ladies,” attorney says of Zimmerman. He became a national figure after being charged, then acquitted in Trayvon Martin's death.
3 London choir is made up of sufferers of neurological conditions, friends and carers. Growing evidence that music has neurological, physical, psychological benefits. Music used to boost rehabilitation of stroke patients, improve motor function. New approaches to music therapy could bring field into mainstream rehab practice.
3 Barack Obama and George Obama share a father, the late Barack Obama Sr. George Obama denies media reports that he's living on a dollar a day. “I think I wanted to learn about my father the same way he did,” George says.
2 Politics is often a family business—not exactly what the founding fathers intended. Nonetheless, our country has a long history of political dynasties The Kennedy, Bush, and Clinton families are just a few of the political dynasties. The Dingells have been in Congress since the Great Depression.
2 Rickie Fowler unveils a patriotic haircut ahead of this week's Ryder Cup. The American has “USA” shaved into the side of his head. The Ryder Cup pits American and European golfers against each other. The 2014 match takes place in Scotland later this week.
1 Emmerich developed obsession with the weather during filming of “10,000 BC”. Film was shot in New Zealand's South Island, South Africa and Namibia. Other challenges include [sic] creating film's ‘terror birds’, shark-like predators. Miniature [sic] pyramids, ‘God's palace’, made in Munich then shipped to Namibia.
1 Perveen Crawford, Hong Kong's first female pilot, shows us around her favorite spots. For the best seafood try Po Toi O a small fishing village in the New Territories. The retro-chic China Club in Central Hong Kong serves traditional Chinese food.

Correlations between DD⁹⁰⁻⁵⁰ and IUN are shown in the table below; the correlations are averaged over the considered clustering cases. The clustering cases are split in several ways: by dataset, by data size (first N samples are selected from a dataset), by clustering algorithm and by the number of resulting clusters.

TABLE 2
Averaged Kendall's τ correlations between the IUM score (by LLM,
B or D) and DD⁹⁰⁻⁵⁰ of the clusters from clustering with embeddings
MPN, L6 or E5, UMAP'ed to dim = 20. The average is taken on splits
by dataset (top 4 rows), by data size (next 4 rows), by clustering algorithm
(next 3 rows), and by number of clusters (last 3 rows).

| | | LLM | | | B | | | D | | |
|---|---|---|---|---|---|---|---|---|---|---|
| | selection | MPN | L6 | E5 | MPN | L6 | E5 | MPN | L6 | E5 |
| dataset | XS | 0.45 | 0.55 | 0.41 | 0.26 | 0.43 | 0.28 | 0.37 | 0.46 | 0.44 |
| | CNN | 0.34 | 0.25 | 0.12 | 0.05 | 0.06 | −0.06 | 0.26 | 0.19 | 0.11 |
| | DM | 0.25 | 0.40 | 0.30 | 0.07 | 0.27 | 0.12 | 0.06 | 0.24 | 0.20 |
| | WN | 0.36 | 0.36 | 0.51 | 0.23 | 0.26 | 0.38 | 0.33 | 0.39 | 0.45 |
| Data | 5000 | 0.36 | 0.39 | 0.31 | 0.15 | 0.25 | 0.16 | 0.29 | 0.34 | 0.29 |
| size | 10000 | 0.36 | 0.40 | 0.34 | 0.15 | 0.27 | 0.18 | 0.25 | 0.34 | 0.30 |
| | 15000 | 0.34 | 0.38 | 0.33 | 0.15 | 0.26 | 0.20 | 0.26 | 0.33 | 0.32 |
| | 20000 | 0.36 | 0.39 | 0.34 | 0.16 | 0.25 | 0.18 | 0.24 | 0.29 | 0.29 |
| clusters | HDBSCAN | 0.43 | 0.46 | 0.39 | 0.20 | 0.29 | 0.25 | 0.29 | 0.34 | 0.34 |
| | KMeans | 0.31 | 0.36 | 0.31 | 0.13 | 0.24 | 0.15 | 0.24 | 0.31 | 0.29 |
| | Agglomerative | 0.32 | 0.36 | 0.30 | 0.13 | 0.24 | 0.15 | 0.24 | 0.32 | 0.28 |
| n_clust | <50 | 0.39 | 0.46 | 0.39 | 0.18 | 0.33 | 0.23 | 0.27 | 0.40 | 0.35 |
| | 50-70 | 0.33 | 0.37 | 0.34 | 0.14 | 0.24 | 0.18 | 0.26 | 0.31 | 0.32 |
| | >70 | 0.33 | 0.35 | 0.27 | 0.14 | 0.2 | 0.13 | 0.24 | 0.27 | 0.24 |

The standard deviation over the clustering cases is disclosed in Table 3. In some clustering cases the correlation may happen to be negative (see Table 4), but with MPN (all-mpnet-base-v2) embeddings the correlation between DD⁹⁰⁻⁵⁰ and IUN is positive in all the covered clustering cases.

TABLE 3
Standard deviation of Kendall's τ correlations between IUN
and DD⁹⁰⁻⁵⁰. The averages of the correlations are in Table 2.

| | | LLM | | | B | | | D | | |
|---|---|---|---|---|---|---|---|---|---|---|
| | selection | MPN | L6 | E5 | MPN | L6 | E5 | MPN | L6 | E5 |
| | XS | 0.10 | 0.10 | 0.06 | 0.11 | 0.11 | 0.09 | 0.08 | 0.08 | 0.06 |
| | CNN | 0.10 | 0.23 | 0.16 | 0.08 | 0.17 | 0.18 | 0.08 | 0.20 | 0.15 |
| | DM | 0.12 | 0.09 | 0.10 | 0.08 | 0.08 | 0.08 | 0.08 | 0.08 | 0.08 |
| | WN | 0.12 | 0.13 | 0.16 | 0.09 | 0.10 | 0.14 | 0.11 | 0.08 | 0.15 |
| Data | 5000 | 0.14 | 0.16 | 0.18 | 0.12 | 0.15 | 0.19 | 0.17 | 0.14 | 0.17 |
| size | 10000 | 0.14 | 0.19 | 0.19 | 0.12 | 0.19 | 0.21 | 0.14 | 0.18 | 0.19 |
| | 15000 | 0.12 | 0.19 | 0.18 | 0.13 | 0.18 | 0.22 | 0.15 | 0.15 | 0.20 |
| | 20000 | 0.13 | 0.20 | 0.21 | 0.15 | 0.20 | 0.23 | 0.13 | 0.18 | 0.19 |
| clusters | HDBSCAN | 0.12 | 0.11 | 0.16 | 0.15 | 0.14 | 0.17 | 0.14 | 0.14 | 0.16 |
| | KMeans | 0.11 | 0.21 | 0.20 | 0.11 | 0.20 | 0.22 | 0.15 | 0.18 | 0.20 |
| | Agglomerativ | 0.13 | 0.19 | 0.20 | 0.12 | 0.19 | 0.22 | 0.15 | 0.16 | 0.20 |
| n_clust | <50 | 0.17 | 0.14 | 0.18 | 0.17 | 0.16 | 0.21 | 0.17 | 0.13 | 0.18 |
| | 50-70 | 0.11 | 0.19 | 0.18 | 0.12 | 0.18 | 0.21 | 0.15 | 0.18 | 0.18 |
| | >70 | 0.09 | 0.20 | 0.19 | 0.09 | 0.17 | 0.21 | 0.13 | 0.16 | 0.19 |

Tables 2 and 3, illustrate the averages and standard deviations of correlations taken over all the considered cases of clustering with UMAP to dimension 20. The fraction of positive correlations was given in Table 4. In Table 10, we extend the clustering cases to several more UMAP versions (Section 2.2), namely “none” (original embeddings, no UMAP), and, in notations of the table, ‘dN-nM’, meaning UMAP to dimension N, with number of neighbors M. We observe no essential difference in the results, except that not using UMAP makes the correlations with IUN a bit worse.

TABLE 4
Fraction of positive Kendall's τ correlations
between IUN and DD⁹⁰⁻⁵⁰. Averages are in Table 2.

| | | LLM | | | B | | | D | | |
|---|---|---|---|---|---|---|---|---|---|---|
| | selection | MPN | L6 | E5 | MPN | L6 | E5 | MPN | L6 | E5 |
| dataset | XS | 1.00 | 1.00 | 1.00 | 1.00 | 0.99 | 1.00 | 1.00 | 1.00 | 1.00 |
| | CNN | 1.00 | 0.87 | 0.75 | 0.79 | 0.61 | 0.36 | 0.99 | 0.79 | 0.76 |
| | DM | 1.00 | 1.00 | 0.99 | 0.82 | 1.00 | 0.95 | 0.80 | 1.00 | 0.98 |
| | WN | 1.00 | 0.99 | 0.99 | 1.00 | 1.00 | 0.98 | 0.99 | 1.00 | 0.99 |
| data | 5000 | 1.00 | 0.98 | 0.95 | 0.92 | 0.94 | 0.81 | 0.97 | 0.98 | 0.95 |
| size | 10000 | 1.00 | 0.96 | 0.92 | 0.89 | 0.89 | 0.83 | 0.93 | 0.93 | 0.92 |
| | 15000 | 1.00 | 0.97 | 0.93 | 0.92 | 0.91 | 0.85 | 0.94 | 0.94 | 0.93 |
| | 20000 | 1.00 | 0.94 | 0.92 | 0.89 | 0.85 | 0.79 | 0.94 | 0.94 | 0.92 |
| clusters | HDBSCAN | 1.00 | 0.99 | 0.99 | 0.94 | 0.96 | 0.95 | 0.99 | 0.99 | 0.99 |
| | KMeans | 1.00 | 0.94 | 0.92 | 0.88 | 0.89 | 0.74 | 0.93 | 0.91 | 0.92 |
| | Agglomerativ | 1.00 | 0.97 | 0.88 | 0.89 | 0.85 | 0.78 | 0.92 | 0.94 | 0.90 |
| n_clust | <50 | 1.00 | 0.99 | 0.99 | 0.85 | 0.99 | 0.85 | 0.94 | 1.00 | 0.99 |
| | 50-70 | 1.00 | 0.96 | 0.96 | 0.89 | 0.87 | 0.83 | 0.94 | 0.93 | 0.96 |
| | >70 | 1.00 | 0.94 | 0.85 | 0.97 | 0.83 | 0.78 | 0.96 | 0.92 | 0.84 |

Table 5 illustrates the role of the “radius” of the whole dataset D90 (from the point of view of the cluster) and the role of the pulled inward “boundary” D50 of the closer half of the dataset (again from the point of view of the cluster) based on all the clustering cases with embedding “MPN” (applying UMAP to dimension 20); showing the correlations of D₉₀ and D₅₀ with LLM-generated IUN score.

TABLE 5
Includes separate correlations of the percentiles D90 and −D50
with IUN. The average (avg), standard deviation (stdev) and the fraction
Fₚₒₛ of positive correlations are taken over all clustering
cases with embedding MPN and UMAP dim = 20.

| correlation with IUN | avg | stdev | Fpos |
|---|---|---|---|
| D₉₀ | 0.07 | 0.15 | 0.7523 |
| −D₅₀ | 0.19 | 0.17 | 0.8528 |
| D₉₀-D₅₀ | 0.35 | 0.13 | 1.0000 |

As shown, the measure DD⁹⁰⁻⁵⁰, the “radius” D90 is designed to be a “beacon” against which we measure the pull of the boundary D50 by the cluster, the pull is stronger if the cluster contains important urgent news. D₉₀ row of the Table 5 illustrates that the averaged correlation is positive not only for −D₅₀, but (to much lesser extent) for D90. Thus, the present invention illustrates that a cluster with important urgent news may appear, due to its novelty, at a location a bit further from established unrelated news. Thus, the preferred method uses the measurements D90 and −D50 combined to deliver a much better correlation with IUN than if considered separately.

This clustering technique (with or without the use of distance methodology disclosed above) provides an accurate, less expensive, and faster means for determining important and urgent news (IUN) than using LLM. In particular, Table 2 (above), illustrates Kendall's τ correlations between IUN score and DD⁹⁰⁻⁵⁰. As understood by those skilled in the art of data science, Kendall's τ correlation is a rank correlation coefficient used in statistics to measure the ordinal association between two measured quantities, which is high when the two observations have a similar (or identical for a correlation of 1) ranking. Here we show the corresponding Spearman correlations in Table 7, structured the same as Table 2 (above).

TABLE 7
Averaged Spearman correlation between the IUN score (by LLM, B or D) and DD⁹⁰⁻⁵⁰ of
the clusters from clustering with embeddings MPN, L6 or E5, UMAP'ed to dim =
20. The average is taken on splits by dataset (top 4 rows), by data size (next 4 rows),
by clustering algorithm (next 3 rows), and by number of clusters (last 3 rows).

| | | LLM | | | B | | | D | | |
|---|---|---|---|---|---|---|---|---|---|---|
| | selection | MPN | L6 | E5 | MPN | L6 | E5 | MPN | L6 | E5 |
| dataset | XS | 0.62 | 0.75 | 0.61 | 0.40 | 0.63 | 0.46 | 0.54 | 0.65 | 0.63 |
| | CNN | 0.48 | 0.35 | 0.17 | 0.08 | 0.10 | −0.12 | 0.40 | 0.28 | 0.16 |
| | DM | 0.38 | 0.58 | 0.44 | 0.10 | 0.39 | 0.19 | 0.10 | 0.38 | 0.30 |
| | WN | 0.52 | 0.51 | 0.68 | 0.35 | 0.37 | 0.54 | 0.49 | 0.55 | 0.63 |
| data | 5000 | 0.50 | 0.55 | 0.44 | 0.23 | 0.37 | 0.24 | 0.42 | 0.49 | 0.42 |
| size | 10000 | 0.51 | 0.56 | 0.49 | 0.23 | 0.39 | 0.27 | 0.37 | 0.49 | 0.43 |
| | 15000 | 0.49 | 0.54 | 0.48 | 0.24 | 0.38 | 0.30 | 0.38 | 0.46 | 0.46 |
| | 20000 | 0.51 | 0.55 | 0.49 | 0.24 | 0.36 | 0.27 | 0.36 | 0.43 | 0.42 |
| clusters | HDBSCAN | 0.59 | 0.63 | 0.55 | 0.28 | 0.42 | 0.36 | 0.43 | 0.49 | 0.48 |
| | KMeans | 0.46 | 0.51 | 0.45 | 0.21 | 0.35 | 0.23 | 0.36 | 0.45 | 0.41 |
| | Agglomerativ | 0.46 | 0.51 | 0.43 | 0.21 | 0.35 | 0.22 | 0.36 | 0.46 | 0.41 |
| n_clust | <50 | 0.55 | 0.63 | 0.55 | 0.26 | 0.47 | 0.34 | 0.40 | 0.57 | 0.49 |
| | 50-70 | 0.48 | 0.52 | 0.48 | 0.21 | 0.35 | 0.27 | 0.38 | 0.44 | 0.46 |
| | >70 | 0.48 | 0.50 | 0.40 | 0.22 | 0.30 | 0.20 | 0.36 | 0.39 | 0.35 |

Similarly. Table 8 (below) is structured as Table 3, but now using Spearman correlations. another measure of the ordinal association between two measured quantities used in statistical analysis. And Table 9 (below Table 8) is structured as Table 4 but using Spearman correlations.

TABLE 8
Standard deviation of Spearman correlations between IUN and
DD⁹⁰⁻⁵⁰. The averages of the correlations are in Table 7.

| | | LLM | | | B | | | D | | |
|---|---|---|---|---|---|---|---|---|---|---|
| | selection | MPN | L6 | E5 | MPN | L6 | E5 | MPN | L6 | E5 |
| dataset | XS | 0.10 | 0.11 | 0.08 | 0.14 | 0.13 | 0.11 | 0.10 | 0.09 | 0.07 |
| | CNN | 0.12 | 0.32 | 0.23 | 0.13 | 0.26 | 0.27 | 0.11 | 0.30 | 0.21 |
| | DM | 0.16 | 0.11 | 0.13 | 0.12 | 0.11 | 0.11 | 0.13 | 0.11 | 0.13 |
| | WN | 0.13 | 0.16 | 0.20 | 0.11 | 0.13 | 0.19 | 0.14 | 0.10 | 0.18 |
| data | 5000 | 0.17 | 0.21 | 0.25 | 0.17 | 0.21 | 0.28 | 0.23 | 0.19 | 0.24 |
| size | 10000 | 0.16 | 0.25 | 0.26 | 0.18 | 0.26 | 0.33 | 0.21 | 0.24 | 0.27 |
| | 15000 | 0.15 | 0.25 | 0.24 | 0.19 | 0.25 | 0.32 | 0.21 | 0.21 | 0.26 |
| | 20000 | 0.15 | 0.26 | 0.28 | 0.21 | 0.28 | 0.34 | 0.19 | 0.25 | 0.27 |
| clusters | HDBSCAN | 0.14 | 0.13 | 0.19 | 0.21 | 0.19 | 0.23 | 0.19 | 0.18 | 0.21 |
| | KMeans | 0.14 | 0.29 | 0.27 | 0.18 | 0.29 | 0.35 | 0.21 | 0.25 | 0.28 |
| | Agglomerative | 0.15 | 0.26 | 0.28 | 0.17 | 0.27 | 0.34 | 0.22 | 0.23 | 0.28 |
| n_clust | <50 | 0.20 | 0.16 | 0.23 | 0.24 | 0.21 | 0.30 | 0.23 | 0.15 | 0.23 |
| | 50-70 | 0.14 | 0.25 | 0.25 | 0.18 | 0.27 | 0.32 | 0.21 | 0.25 | 0.25 |
| | >70 | 0.11 | 0.28 | 0.27 | 0.13 | 0.25 | 0.32 | 0.18 | 0.23 | 0.28 |

TABLE 9
Fraction of positive Spearman correlations between IUN and
DD⁹⁰⁻⁵⁰. The averages of the correlations are in Table 7.

| | | LLM | | | B | | | D | | |
|---|---|---|---|---|---|---|---|---|---|---|
| | selection | MPN | L6 | E5 | MPN | L6 | E5 | MPN | L6 | E5 |
| dataset | XS | 1.00 | 1.00 | 1.00 | 1.00 | 0.99 | 1.00 | 1.00 | 1.00 | 1.00 |
| | CNN | 1.00 | 0.86 | 0.71 | 0.74 | 0.62 | 0.36 | 0.99 | 0.81 | 0.75 |
| | DM | 1.00 | 1.00 | 0.99 | 0.81 | 1.00 | 0.96 | 0.79 | 1.00 | 0.97 |
| | WN | 1.00 | 1.00 | 1.00 | 1.00 | 1.00 | 0.97 | 0.99 | 1.00 | 0.98 |
| data | 5000 | 1.00 | 0.98 | 0.94 | 0.89 | 0.95 | 0.81 | 0.96 | 0.98 | 0.94 |
| size | 10000 | 1.00 | 0.95 | 0.91 | 0.88 | 0.90 | 0.83 | 0.93 | 0.93 | 0.91 |
| | 15000 | 1.00 | 0.97 | 0.93 | 0.92 | 0.91 | 0.85 | 0.93 | 0.95 | 0.92 |
| | 20000 | 1.00 | 0.95 | 0.91 | 0.87 | 0.84 | 0.80 | 0.94 | 0.94 | 0.92 |
| clusters | HDBSCAN | 1.00 | 1.00 | 0.99 | 0.93 | 0.96 | 0.94 | 0.99 | 1.00 | 0.98 |
| | KMeans | 1.00 | 0.94 | 0.92 | 0.85 | 0.89 | 0.76 | 0.93 | 0.92 | 0.91 |
| | Agglomerative | 1.00 | 0.96 | 0.86 | 0.88 | 0.86 | 0.78 | 0.90 | 0.94 | 0.89 |
| n_clust | <50 | 1.00 | 1.00 | 0.99 | 0.83 | 0.99 | 0.87 | 0.94 | 1.00 | 0.99 |
| | 50-70 | 1.00 | 0.95 | 0.94 | 0.87 | 0.88 | 0.83 | 0.93 | 0.94 | 0.96 |
| | >70 | 1.00 | 0.94 | 0.85 | 0.96 | 0.84 | 0.77 | 0.96 | 0.92 | 0.83 |

### Gaps Between IUN and DD⁹⁰⁻⁵⁰ Ranks

Kendall's r correlation is based on account of concordant ad discordant paired observations, and it gives a good account of how agreeable two values (in our case, IUN and DD⁹⁰⁻⁵⁰) when ranked. It would be also illustrative to see how far from each other the ranks of the same cluster accordingly to IUN score vs DD⁹⁰⁻⁵⁰. Table 10 showing the correlation is found below:

TABLE 10
Kendall's τ correlation between the IUN score (by LLM, B or D)
and DD⁹⁰⁻⁵⁰ feature of the clusters from clustering with
embeddings MPN, L6 or E5. The clustering is done with all considered (datasets,
data sizes, clustering algorithms, embeddings and UMAP versions).
The results are split by UMAP version. The top horizontal pane
shows average avg of the correlations; the second one shows standard deviation stdev,
and the last one shows the fraction of positive correlations Fₚₒₛ.

| | | LLM | | | B | | | D | | |
|---|---|---|---|---|---|---|---|---|---|---|
| | UMAP | MPN | L6 | E5 | MPN | L6 | E5 | MPN | L6 | E5 |
| avg | none | 0.30 | 0.14 | 0.23 | 0.16 | 0.04 | 0.11 | 0.18 | 0.09 | 0.17 |
| | d10-n10 | 0.33 | 0.40 | 0.32 | 0.15 | 0.26 | 0.18 | 0.24 | 0.33 | 0.30 |
| | d20-n10 | 0.35 | 0.39 | 0.33 | 0.15 | 0.25 | 0.18 | 0.26 | 0.32 | 0.30 |
| | d10-n30 | 0.38 | 0.38 | 0.34 | 0.21 | 0.26 | 0.2 | 0.34 | 0.32 | 0.30 |
| stddev | none | 0.23 | 0.27 | 0.18 | 0.21 | 0.25 | 0.17 | 0.19 | 0.20 | 0.18 |
| | d10-n10 | 0.14 | 0.17 | 0.20 | 0.15 | 0.17 | 0.22 | 0.14 | 0.16 | 0.21 |
| | d20-n10 | 0.13 | 0.18 | 0.19 | 0.13 | 0.18 | 0.21 | 0.15 | 0.16 | 0.19 |
| | d10-n30 | 0.14 | 0.21 | 0.21 | 0.13 | 0.20 | 0.23 | 0.16 | 0.21 | 0.21 |
| Fₚₒₛ | none | 0.83 | 0.73 | 0.87 | 0.76 | 0.63 | 0.78 | 0.80 | 0.68 | 0.81 |
| | d10-n10 | 0.98 | 0.96 | 0.91 | 0.86 | 0.90 | 0.82 | 0.94 | 0.96 | 0.90 |
| | d20-n10 | 1.00 | 0.96 | 0.93 | 0.90 | 0.90 | 0.82 | 0.95 | 0.95 | 0.93 |
| | d10-n30 | 0.98 | 0.91 | 0.88 | 0.93 | 0.88 | 0.78 | 0.99 | 0.89 | 0.90 |

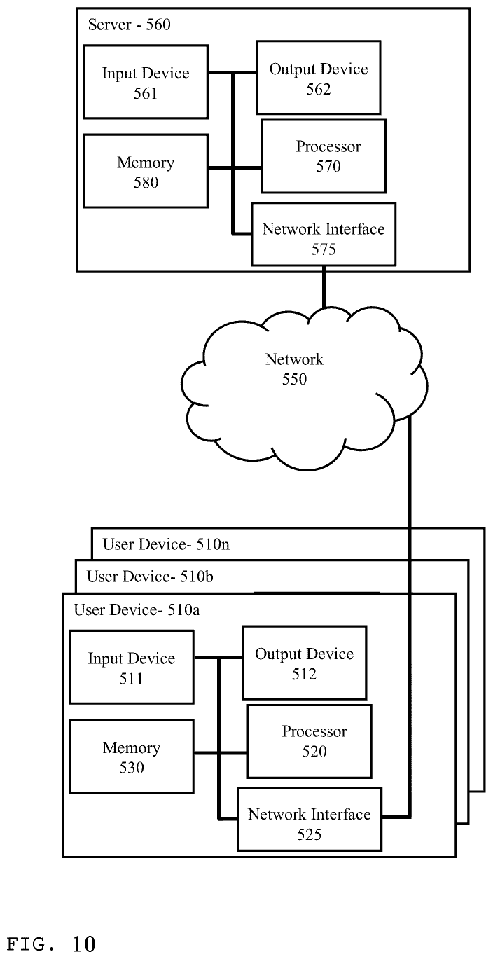

FIG. 9 illustrates the accumulated normalized curve of the gaps between the ranks. The gaps are normalized to total number of clusters in each clustering case. The counts are taken over all our clustering cases with MPN embedding (UMAPed to dim=20). IUN is by LLM (GPT3.5-Turbo). With account of all the clustering cases (“Any number of clusters” curve in FIG. 9), the gap between the ranks is less than 10% (of the total number of clusters) for half of the clusters. The gap is limited by 50% for 97.9% of the clusters.

Tables 2, 3 and 4 illustrate that the relation between IUN and DD⁹⁰⁻⁵⁰ is stronger for not too high number of clusters. Indeed, accounting for only the clustering cases with more than 50 clusters (“more than 50 clusters” curve in FIG. 9) increases the gaps in the distribution. And limiting the number of clusters to not more than 50 decreases the gaps (“No more than 50 clusters” curve in FIG. 9). In this favorable setting, 73.5% of clusters have the gap (between IUN and DD⁹⁰⁻⁵⁰ ranks) within 10% of the total number of clusters. And 99.2% of clusters have gap within 30%, and there are no clusters with gap more than 42%.

A few simple measures can help in succinct characterization of the accumulative curve between the ranks. We present such measures as the columns in Table 11.

TABLE 11
Median, average (avg) and 97.5% percentile (P97.5)
of gaps between IUN and DD⁹⁰⁻⁵⁰ ranks. Normalized
to 100, similar to the X-axis in FIG. 9.

| Number of clusters | median | avg | P 97.5 |
|---|---|---|---|
| <=50 | 6 | 7.62 | 26 |
| All | 10 | 14.35 | 49 |
| >50 | 15 | 18.78 | 54 |

The three rows in the table correspond to the three curves of FIG. 9. For example, the first row (not more than 51 clusters) shows that the median of the difference between DD⁹⁰⁻⁵⁰ and IUN ranks of the same cluster would be 6% of the total number of clusters. This means that, for example, that when averaged over all clustering cases resulting in exactly 50 clusters, the median of the difference between DD⁹⁰⁻⁵⁰ and IUN ranks will be equal to 3. The second column shows the average (rather than median) of the difference between the ranks. In the first row it is 7.62% of the total number of clusters. Finally, the third column shows 97.5% percentile P 97.5. In the first row it shows that for 97.5% of all the clusters the DD⁹⁰⁻⁵⁰ rank would be within 26% (of total number of clusters) from IUN rank.

### Other Examples of Cluster Properties

Table 12 illustrates examples of a few more similar cluster features, by replacing D₅₀ with distance percentiles between 10% and 65%. (Changing “radius” from 90% to 85% or to 95% makes all the rows slightly worse; this is not shown in the table.) Using the percentiles 15%-45% instead of D50 provides as good or even better correlations with IUN (at least averaged across all the clustering cases), especially 20%. This appears to happen due to stronger “pull” in the vicinity of the important urgent news cluster. But it also possible that replacing D50 by a lesser percentile, and thus sampling less of the “pull” volume, makes the correlations less robust (column Fₚₒₛ). On the other hand, using a percentile above 50%, while adding weaker “pull” volume, reduces the difference with D90. Thus, altogether the D90−D50 row in Table 12 appears to be the safe choice.

TABLE 12
Correlation of several similar cluster features (column 1)
with IUN. The average (avg), standard deviation (stdev) and the
fraction Fₚₒₛ of positive correlations are taken over all
clustering cases with embedding MPN and UMAP dim = 20.

| correlation with IUN | avg | stdev | Fpos |
|---|---|---|---|
| D90-D10 | 0.34 | 0.16 | 0.9930 |
| D90-D15 | 0.39 | 0.13 | 0.9953 |
| D90-D20 | 0.38 | 0.12 | 0.9977 |
| D90-D25 | 0.36 | 0.12 | 0.9977 |
| D90-D30 | 0.36 | 0.13 | 0.9977 |
| D90-D35 | 0.35 | 0.13 | 0.9953 |
| D90-D40 | 0.35 | 0.13 | 0.9977 |
| D90-D45 | 0.35 | 0.13 | 0.9977 |
| D90-D50 | 0.35 | 0.13 | 1.0000 |
| D90-D55 | 0.35 | 0.14 | 0.9977 |
| D90-D60 | 0.34 | 0.14 | 0.9883 |
| D90-D65 | 0.33 | 0.15 | 0.9860 |

All this helps in assessing how accurate, in sense of using DD⁹⁰⁻⁵⁰ instead of IUN, would be a removal of certain number of clusters with lowest DD⁹⁰⁻⁵⁰ scores, or a selection of certain number of clusters with top DD⁹⁰⁻⁵⁰ scores. In any case, according to our understanding (discussion of Table 5), the DD⁹⁰⁻⁵⁰ score reflects importance and urgency of news in its own way, even if it does not exactly coincide with IUN generated by LLM.

In discussing Table 5, we considered D90 as a “beacon” (or a “radius”) against which to measure the “pull” of importance and urgency of the news in the cluster. It is worth to note that ignoring that consideration and choosing the “beacon” haphazardly leads to worse results. For example, replacing the 90% percentile of the distances by their average ‘A’ would produce (for A−D50), in Table 12, the values avg=0.25, stdev=0.17 and Fpos=0.9180.

On the other hand, there may be possibilities for measures with even better correlations (with LLM-generated IUN) than D90-D50. It may be possible to strike a good balance between stronger and weaker pull areas, for example combining D50 and D20. The measure

$$2 {D}_{90} - {D}_{50} - {D}_{20} \qquad ( 2 )$$

would have, in Table 12, the values avg=0.37, stdev=0.12 and Fpos=1.0000. This is better than D₉₀−D₅₀. But simplicity makes always a better promise of robustness, and that is why we left DD⁹⁰⁻⁵⁰ as our recommended example.

The experiments, thus, prove there is a strong correlation between a simple property DD⁹⁰⁻⁵⁰ of clusters in a clustered dataset and the computationally more-expensive LLM scored IUN across several news datasets, data sizes, clustering algorithms and text embeddings. Accordingly, the novel systems and methods disclose herein provide mechanisms for quickly and inexpensively finding important urgent news (IUN), without the need to use LLM (or other models) to score IUN.

### Computing Environment to Systems and Methods Disclosed

The operations implemented to facilitate the foregoing systems and methods including, data collection, clustering, and other various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Aspects of the methods and systems described herein, such as the logic or machine learning models, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

Aspects of the methods and systems disclosed herein may be embodied and/or executed by the logic of the processes described herein, which may also be embodied in the form of software instructions and/or firmware that may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors, for example.

Aspects of the methods and systems described herein may also be implemented on an illustrative system 500, depicted in association with FIG. 10. In particular, system 500 may comprise a user devices 510a-n, server 560, and network 550.

The user device 510 of the system 500 may include various components including, but not limited to, one or more input devices 511, one or more output devices 512, one or more processors 520, a network interface device 525 capable of interfacing with the network 550, one or more non-transitory memories 530 storing processor executable code and/or software application(s), for example including, a web browser capable of accessing a website and/or communicating information and/or data over the network, and/or the like. The memory 530 may also store an application (not shown) that, when executed by the processor 520 causes the user device 510 to provide the functionality of the various systems and methods described the present specification, as would be understood by those of ordinary skill in the art having the present specification before them.

The input device 511 may be capable of receiving information input from the user and/or processor 520 and transmitting such information to other components of the user device 510 and/or the network 550. The input device 511 may include, but are not limited to, implementation as a keyboard, touchscreen, mouse, trackball, microphone, remote control, and combinations thereof, for example.

The output device 512 may be capable of outputting information in a form perceivable by the user and/or processor 520. For example, implementations of the output device 512 may include, but are not limited to, a computer monitor, a screen, a touchscreen, an audio speaker, a website, and combinations thereof, for example. It is to be understood that in some exemplary embodiments, the input device 511 and the output device 512 may be implemented as a single device, such as, for example, a computer touchscreen. It is to be further understood that as used herein the term “user” is not limited to a human being, and may comprise, a computer, a server, a website, a processor, a network interface, a user terminal, and combinations thereof, for example.

The server 560 of the system 500 may include various components including, but not limited to, one or more input devices 561, one or more output devices 562, one or more processors 570, a network interface device 575 capable of interfacing with the network 550, and one or more non-transitory memories 580 for storing data structures/tables (including those of database 585) that may be used by the system 500 and particularly server 560 to perform the functions and procedures set forth herein. The memory 580 may also store an application/program store 581 that, when executed by the processor 570 causes the server 560 to provide the functionality of the systems and methods disclosed in the present application.

As shown in FIG. 10, the server 560 may include a single processor or multiple processors working together or independently to execute the program logic 581 stored in the memory 580 as described herein. It is to be understood, that in certain embodiments using more than one processor 570, the processors 570 may be located remotely from one another, located in the same location, or comprising a unitary multi-core processor. The processors 570 may be capable of reading and/or executing processor executable code and/or capable of creating, manipulating, retrieving, altering, and/or storing data structures and data tables (including those of database 585) into the memory 580.

Exemplary embodiments of the processor 570 may be include, but are not limited to, a digital signal processor (DSP), a central processing unit (CPU), a field programmable gate array (FPGA), a microprocessor, a multi-core processor, combinations, thereof, and/or the like, for example. The processor 570 may be capable of communicating with the memory 580 via a path (e.g., data bus). The processor 570 may be capable of communicating with the input device 561 and/or the output device 562.

The input device 561 of the server 560 may be capable of receiving information input from the user and/or processor 570 and transmitting such information to other components of the server 560 and/or the network 550. The input device 561 may include, but are not limited to, implementation as a keyboard, touchscreen, mouse, trackball, microphone, remote control, and/or the like and combinations thereof, for example. The input device 561 may be located in the same physical location as the processor 570 or located remotely and/or partially or completely network based.

The output device 562 of the server 560 may be capable of outputting information in a form perceivable by the user and/or processor 570. For example, implementations of the output device 562 may include, but are not limited to, a computer monitor, a screen, a touchscreen, an audio speaker, a website, a computer, and/or the like and combinations thereof, for example. The output device 562 may be located with the processor 570 or located remotely and/or partially or completely network-based.

The memory 580 stores applications or program logic 581 as well as data structures (including those of database 585) that may be used by the system 500 and particularly server 560. The memory 580 may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like, for example. In some embodiments, the memory 580 may be located in the same physical location as the server 560, and/or one or more memory 580 may be located remotely from the server 560. For example, the memory 580 may be located remotely from the server 560 and communicate with the processor 570 via the network 550. Additionally, when more than one memory 580 is used, a first memory 580a may be located in the same physical location as the processor 570, and additional memory 580n may be located in a location physically remote from the processor 570. Additionally, the memory 580 may be implemented as a “cloud” non-transitory computer readable storage memory (i.e., one or more memory 580 may be partially or completely based on or accessed using the network 550).

Each element of the server 560 may be partially or completely network-based or cloud based and may or may not be located in a single physical location. As used herein, the terms “network-based,” “cloud-based,” and any variations thereof, are intended to include the provision of configurable computational resources on demand via interfacing with a computer and/or computer network, with software and/or data at least partially located on a computer and/or computer network. In other words, the server 560 may or may not be located in single physical location. Additionally, multiple servers 560 may or may not necessarily be located in a single physical location.

Database 585 may comprise one or more data structures and/or data tables stored on non-transitory computer readable storage memory 580 accessible by the processor 570 of the server 560. The database 585 can be a relational database or a non-relational database. Examples of such databases include, but are not limited to: DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 585 can be centralized or distributed across multiple systems.

While particular embodiments of the present invention have been shown and described, it should be noted that changes and modifications may be made without departing from the presently disclosed inventive concepts in its broader aspects and, therefore, the aim in the appended claims is to cover all such changes and modifications as fall within the true spirit and scope of this invention.

What is claimed is:

1. A method for automatically identifying important and urgent news (IUN) in a large set of data:
obtaining the large set of data in a textual-format, the large set of textual-data data contain a plurality of individual texts;
clustering the textual-format data into a plurality of clusters;
for each cluster, calculating the distances to all other clusters in the plurality of clusters and from those calculated distances determining a radius and a median of those calculated distances and then obtaining a difference between the radius and the median; and
using the difference to identify important and urgent news in the large set of data.

2. The method of claim 1 wherein the radius calculated using 90% rather than 100%.

3. The method of claim 1 further comprises applying a dimension reduction technique to the textual-format data before clustering.

4. The method of claim 1 wherein the clustering is performed using one or more techniques selected from the group comprising: HDBSCAN, Agglomerative, and KMeans.

5. A system for automatically identifying important and urgent news (IUN) in a large set of data utilizing the method of claim 1.
